(19) United States
(12) Patent Application Publication
(10) Pub. No.: US 2006/0182880 A1
(43) Pub. Date: Aug. 17, 2006

(54) Method and equipment for producing cables with peroxide cross linked insulating and semiconducting layers

(75) Inventor: Hans Walter Gitschner, Bergisch Gladbach (DE)

Correspondence Address: JORDAN AND HAMBURG LLP, 122 EAST 42ND STREET, SUITE 4000, NEW YORK, NY, 10168, US

(73) Assignee: Troester GmbH & Co. KG, Hannover (DE)

(21) Appl. No.: 11/046,264

(22) Filed: Jan. 27, 2005

(30) Foreign Application Priority Data
Jan. 30, 2004 (DE) 10 2004 004 910.6

(51) Int. Cl. B05D 5/12; H05B 6/02; H05B 6/24

(52) U.S. Cl. 427/117; 427/591; 118/724; 118/420

(57) ABSTRACT

An installation for cross-linking an insulation layer or semiconductor layer of a cable, which is being produced and which passes through a reaction chamber filled with hot inert gas under pressure, provides that the conductor or conductors, as they progress through the reaction chamber and, accordingly, as the cross-linking progresses, are heated more strongly by inductive heating. Due to this measure, the cross-linking, which progresses from the inside and the outside to the center of the insulation layer or semiconductor layer and is associated with an increase in dimensional stability, is utilized for letting the cross-linking proceed more rapidly by increasing the temperature in the interior, that is, in the conductor. In this connection, the increase in dimensional stability of the insulation and/or semiconductor layer, which sets in as the cross-linking progresses, is utilized in order to increase the temperature of the conductor even more. At the end of the cross-linking zone, a degassing zone is created by a further increase in temperature. In this degassing zone, a rapid escape of gas from the cable in a relatively short segment of the reaction chamber is brought about by inductive heating of the conductor or conductors.

The invention relates to a method for cross-linking an insulation or semiconductor layer of a cable, which is in the process of being produced and is passing through a reaction chamber, which is filled with hot inert gas under pressure.

Especially for the production of high voltage and highest voltage cables, insulation and semiconductor layers are cross-linked, in order to confer a special stability on these layers. For this purpose, a cross-linking agent, usually a peroxide, which decomposes under the action of heat and, in so doing, brings about the cross-linking, is added to the extrudate forming these layers. It is therefore necessary in the production process to keep the temperatures as low as possible in the extruder and in the downstream transversal extruder head, in which the conductor or conductors is/are coated, so that the cross-linking does not already commence in this equipment. In the reaction chamber, which usually is a long pipe downstream from the transversal extruder head, the temperature of the cable being formed must be increased for the cross-linking. This is usually done by bathing the resulting cable in a hot, inert gas. As a result, cross-linking of the insulation and/or semiconductor layer commences, progressing from the outside to the inside. Since this cross-linking proceeds only slowly, a very long reaction chamber is required. In order to reduce this length by accelerating the cross-linking, the conductor or conductors is/are heated by an induction heater, which is disposed in front of or better yet closely behind the transversal extruder head, so that heat flows not only from the outside to the inside by convection, but also from the inside to the outside by conduction. However, in the case of this induction heating, it is necessary to take care that the temperature in the insulation or semiconductor layer does not come close to or even exceed the melting point of the material, which is to be cross-linked, so that the shape, given to the cable in the transversal extruder head, is not lost by drop effects.

Since gaseous breakdown products are formed during the cross-linking reaction due to the decomposition of the dicumyl peroxide, the cross-linking process is carried out under a pressure of 10 to 16 bar in order to avoid gassing and pore formation. The cooling process, which is also carried out under pressure, commences immediately after the cross-linking process and is generally carried out in the same pipe. So that a high content of breakdown products does not cause pores to be formed in the extrudate surrounding the conductor or conductors, a long-lasting aftertreatment is required during storage of the finished cable. The degassing time can be shortened by storage in heated chambers at temperatures of 50° to 80° C. However, the inherent weight of the cables is an obstacle during the rearrangement in heated chambers. Moreover, all of these measures are expensive and cost intensive. The problem of degassing extrudable materials is known from the application and construction of extruders.

Very rapid degassing takes place in extruders in a degassing zone, where, by reducing the core diameter of the screw over a short distance, the degree of filling, which otherwise is high, is reduced greatly and the pressure by an external gas can be aspirated into the vacuum source. However, this is not possible here during the treatment of the insulation and/or semiconductor layers of a cable, because this treatment must be carried out under pressure and does not tolerate a vacuum. The invention avoids the disadvantages of the state of the art. It is an object of the invention to carry out the cross-linking and the degassing more quickly and at a lower cost. The invention achieves this acceleration of the cross-linking owing to the fact that the conductor or conductors is/are heated more strongly by inductive heating as the cross-linking progresses in the cross-linking zone of the reaction chamber. Behind the cross-linking zone and before the cooling, a zone is introduced in the reaction chamber, in which degassing is carried out by inductively heating the conductor or conductors strongly.

It is of advantage if simultaneously, as the cable advances in the reaction chamber and, associated therewith, as the outer layer of the insulation or semiconductor layer of the cable becomes more cross-linked, the heated inert gas atmosphere, surrounding the cable in the reactor chamber, is heated more strongly. This can be accomplished by heating the reactor chamber from the outside. It can also be accomplished by cycling the inert gas and heating this cycling gas. As a result of this measure, the cross-linking, which is progressing from the inside and the outside to the center of the insulation or semiconductor layer and is associated with increasing the dimensional stability, is utilized for letting the cross-linking progress more rapidly by raising the temperature in the interior, that is, in the conductor. Moreover, as the cross-linking progresses, the greater dimensional stability setting in is utilized in order to increase the temperature of the conductor even further. Accordingly, it is possible to achieve an exponential advance of the cross-linking with time (residence time in the reactor) or with the length of the migration through the reactor and, as a result, also to shorten the previously customary reactor length.

Advisably, the inductive heating is not carried until the cross-linking at the outside of the cable has brought about a dimensionally stable cross-linking of the outer layer due to the convective transfer of heat of the hot inert gas. By proceeding in such a manner, it is ensured that the cable, which is being produced, retains the exact shape that it had received in the transversal extruder head.

It is likewise appropriate that the inductive heating is not carried out until when the cross-linking at the inner side of the insulation or semiconductor layer, facing the conductor or the conductors, has brought about a dimensionally stable cross-linking of the inner layer of the insulation or semiconductor layer due to the heat supplied initially to the conductor or conductors.

For this method, it has proven to be advantageous to carry at the heating up to the melting point of the material, from which the insulation or semiconductor layer is produced.

By means of these measures, the invention succeeds in carrying out the cross-linking more rapidly and less expensively in a shorter reactor chamber. This is so for cables, which require degassing, as well as for cables, which do not have to be degassed.

For cables, which require degassing, the invention proceeds with the same means of inductive heating and consists therein that, even before it is cooled, the cross-linked cable is degassed in a degassing segment by increasing its temperature in the pressurized atmosphere.

Advisably, this degassing takes place in the same reactor chamber in the same pressurized atmosphere of inert gas.

For the state of the art, the process of cross-linking takes place in a pressurized reactor pipe, heat being supplied, and, at the end of the reactor pipe, there is a (pre-)cooling zone. On the other hand, for the invention, a further zone, the degassing zone, in which more heat is supplied to the cable internally and externally, is inserted in the reacted chamber behind the cross-linking zone. This degassing zone precedes the cooling zone. Accordingly, the whole process of cross-linking and degassing takes place in a reactor chamber before the cooling process.

The temperature level in the degassing zone is increased in the cable from the inside by additionally heating the conductor inductively at the end of or shortly before the end of the cross-linking segment before the cable enters the degassing segment. The temperature is increased from the outside by increasing the temperature of the pressurized atmosphere surrounding the cable.

This is a relatively simple, but quite effective measure, which enables the gaseous breakdown products to emerge from the insulation or semiconductor layer of the wire conductor while the cable is in the degassing segment and before it reaches the cooling segment. This makes it possible not only to save energy because of the omission of the reheating of an already cooled cable, but also to increase the production rate appreciably by the omission of the storage time.

The inert gas must be cleaned from time to time and, better yet, constantly, so that the breakdown products do not assume an excessively large partial pressure in the pressurized atmosphere of the cross-linking and degassing zone, which could affect the surface of the cable as well as hinder the emergence of these gaseous breakdown products from the cross-linked layer or layers. Advisably, therefore, and for saving more energy, the inert gas of the degassing segment is subjected to a purification for removing the breakdown products from the cross-linking reaction.

It may be appropriate to pass the inert gas of the degassing segment together with the inert gas from the cross-linking segment into a cycle through the purification equipment. Since the temperatures in the degassing segment and the cross-linking segment maybe appreciably different, it is appropriate, in this case, if the inert gas of the degassing segment is passed separately from the inert gas of the cross-linking segment into a cycle through the purification equipment

In spite of these measures, the gaseous breakdown products may be present in a small amount in the insulation and/or semiconductor layer of the cable, even after the latter has left the reactor pipe. If necessary, a final degassing then takes place briefly before or during the winding up in the temperature-holding segment at a temperature of 40° to 100° C. and preferably of 55° 75° C. or in heating chambers

Preferably, deformation of the cable during the cooling can be eliminated by reheating to a temperature range a little below the melting point or higher in order to activate the restoring forces and memory effects.

For the degassing, it is advantageous if the conductor in the degassing segment is heated by induction heating. The breakdown products are then liberated preferably in the vicinity of the conductor and, during the further migration of the cable, can migrate to the outside, where they diffuse into the pressurized atmosphere of the degassing segment.

The inert gas, already used and purified, can be used once again owing to the fact that, after it has been purified and before it renters the degassing segment, it is heated to the temperature necessary for the degassing.

It has proven to be particularly advantageous if the cross-linking, the degassing and the subsequent pre-cooling are carried out in the same pipe. The individual sections of this pipe for the cross-linking, the degassing and the subsequent pre-cooling are subdivided by the inlet and outlet connecting pieces for the warm, heated and cooled inert gas.

A further possibility for delineating the individual sections of the pipe consists therein that the cross-linking, the degassing and the subsequent pre-cooling are carried out in a common pipe, in which the individual sections for the cross-linking, the degassing and the subsequent pre-cooling are subdivided by locks or constrictions for the warm, heated and cooled inert gas.

The equipment, with which the above-described method for producing cables with the peroxide cross-linked insulation and/or semiconductor layers can be carried out, consists of a conductor unwinding device, a transversal extruder head for applying the insulation and/or semiconductor layer, a heated reactor for the cross-linking, a cooling segment as well as a cable winding-up device. The invention consists therein that the conductor or the conductors are heated increasingly by inductive heating as the movement in the reactor chamber progresses and, accordingly, as the cross-linking progresses. It is also inventive that a degassing zone, filled with inert gas and working at an elevated temperature and under pressure, is disposed between the cross-linking segment and the cooling segment in the reactor. This degassing segment serves for discharging the gaseous breakdown products from the cross-linking extrudate on the conductor or conductor bundle already in the state of formation, so that the cable enters the cooling segment with a smooth surface and a greatly decreased content of breakdown products, which accordingly, after passing through the cooling segment, no longer have to be removed with special expenditure of energy and special expenditure for and especially expensive downstream parts of the equipment. This permits degassing to be carried out more quickly and less expensively. A particularly high temperature level of the cable immediately in front of the cooling segment is utilized in order to increase the temperature for a short period by inductively supplying further energy to the conductor or conductors, in order to remove the bulk of the gaseous breakdown products before entry into the cooling segment. This makes it unnecessary to reheat the cable for the degassing after it has already been cooled and accordingly saves energy. The completion of the cable is accelerated by these means and the manufacturing costs are reduced.

For this equipment, it is not only appropriate but, in most cases, also necessary that a cleaning device be connected to the degassing segment in a parallel circuit, by means of which the inert gas, which has entered and is contained in the degassing segment, is removed in a cycle.

However, gaseous breakdown products of the cross-linking agent also emerge from the extruded coating of the conductor already in the cross-linking segment. In order to remove also these from the equipment, it is appropriate that the inert gas from the cross-linking segment, together with or separately from the inert gas from the degassing segment, is cycled through the cleaning device.

This can be done in the cleaning device in the one inert gas cycle for the cross-linking segment and the degassing segment. However it can also be done in separate cycles and separate cleaning devices. The breakdown gases from the cooling device can be removed separately in an additional cycle by a further cleaning device. The cleaning in separate cycles appears to be more expensive, but is not, because the different cycles have different temperature levels and the energy of reheating or cooling is saved.

The cross-linking segment can be separated from the degassing segment and the cooling segment by constrictions in the pipe.

Advisably, at least one heating device for replenishing the heat losses that have occurred is provided in the inert gas cycle at the degassing segment. Accordingly, it is advantageous if, at the entry of the degassing segment, an induction heater is provided in the latter for heating the conductor. At the end of the cleaning segment, assigned to the degassing segment, a heater is provided for the purified inert gas.

This equipment advantageously is configured owing to the fact that a common pipe is provided for the cross-linking, the degassing and the subsequent cooling. This pipe is divided into individual sections for the cross-linking, the degassing and the subsequent cooling by connecting pieces for supplying and discharging the warm, heated and cooled inert gas.

There is, however, also the not less advantageous design possibility for the equipment that a common pipe is provided for the cross-linking, the degassing and the subsequent cooling and that the individual sections for the cross-linking, the degassing and the subsequent cooling are subdivided by locks or constrictions for the warm, heated and cooled inert gas.

If there is no such separation of the cross-linking, degassing and cooling segments, it is advisable to provide only one inert gas cycle with only one cleaning device.

The essence of the present invention is explained in greater detail by means of examples shown in the drawing, in which

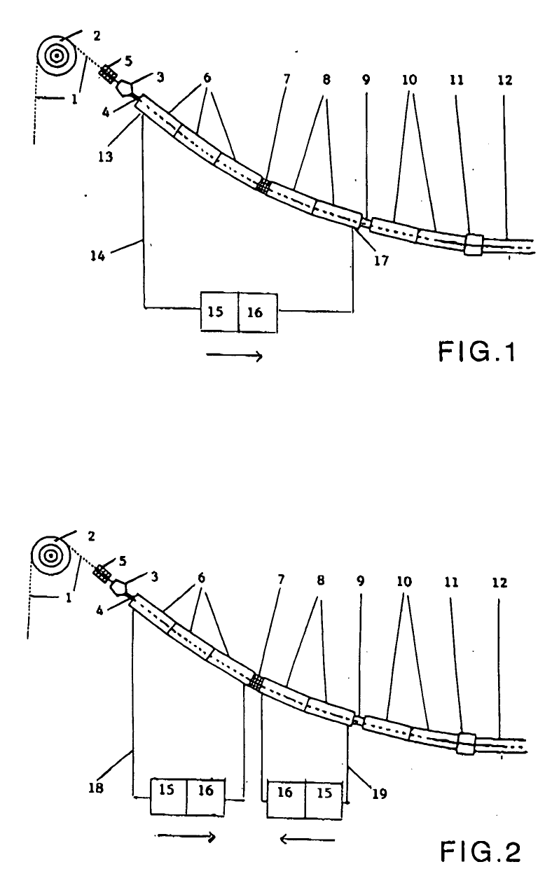

FIG. 1 shows an installation, built in a catenary, with a regeneration segment for the inert gas in the reactor,

FIG. 2 shows an installation, built in a catenary, with two regeneration segments for the inert gas in the cross-linking segment and in the degassing segment of the reactor,

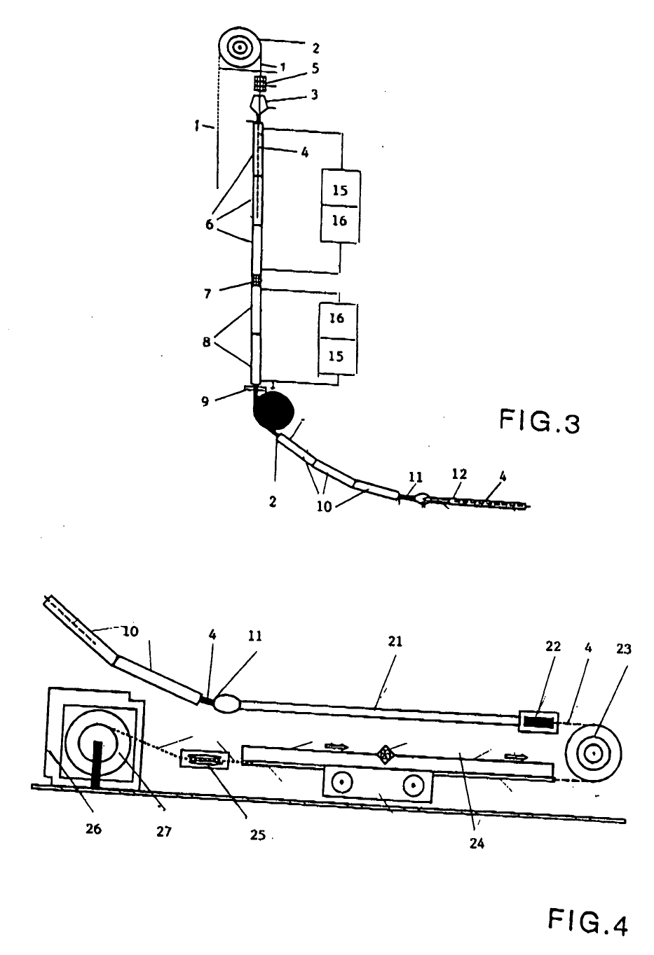

FIG. 3 shows vertically constructed equipment with two regeneration segments for the inert gas in the cross-linking segment and the inert gas in the degassing segment of the reactor and

FIG. 4 shows the further treatment of the cable emerging from the pre-cooling zone 10 of the catenary reactor pipe in the cooling segment.

In the drawing, the various installations named are shown. Of these, the conductor 1 initially is guided over a guide wheel 2. This conductor 1 is then coated in the transversal extruder head 3, which is supplied by an extruder that is not shown, with an insulation and/or semiconductor layer and leaves the transversal extruder head 3 as an unfinished cable 4, the insulation and/or semiconductor layer of which still needs to be cross-linked.

This cross-linking takes place in a pressurized, inert gas atmosphere in a heated pipe 6, which serves as reactor and is assembled from several pipe sections. To begin with, the insulation and/or semiconductor layer must not be heated above its melting temperature. However, after a certain dimensional stability has been achieved by the onset of cross-linking, the temperature must be set as high as possible, so that the cross-linking then proceeds rapidly. The cable 4 is heated externally by hot inert gas flowing around it. However, the cable 4 is also heated internally by inductive heating of the conductor 1 by means of the induction heating device 5, which is disposed immediately in front of the transversal extruder head 3, so that the conductor 1, already preheated, is coated with the insulation and/or semiconductor layer and gives off heat from inside to the insulation and/or semiconductor layer.

This induction heating can be installed once or several times, for example, at places where individual pipes of the reactor are flanged to one another.

In the cross-linking region 6 of the tubular reactor, the cross-linking agent, added to the insulation and/or semiconductor layer already before the extrusion, is decomposed by heat and broken down partly or completely into gaseous components, which escape from the cable during a long-lasting process at ambient temperature. During this time, the cable cannot be employed for its intended use.

The cross-linking and the escape of the gaseous decomposition products can be accelerated. This is done by heating the insulation and/or semiconductor layer above the melting temperature, which is possible, when the cross-linking has proceeded so far, that the insulation and/or semiconductor layer no longer loses its dimensional stability by being heated above its melting temperature.

This is done in a separate degassing region, installed in the tubular reactor, with the pipe sections 8 and the induction heater 7 preceding the pipe sections 8. In the degassing region 8, the insulation and/or semiconductor layer is heated from outside by inert gas heated above the melting temperature of the insulation and/or semiconductor layer, while the cable 4 is heated from inside by the induction heater 7 above the melting temperature of the insulation and/or semiconductor layer. Compared to the cross-linking region 6, increased amounts of gaseous decomposition products of the cross-linking agent occur at this time.

The cross-linking region 6 and the degassing region 8 are separated from one another by a constriction in the reactor pipe, so that the different temperatures in the two regions can be held at the values intended for them. This constriction is formed by the induction heater 7.

At the end of the cross-linking region 8 in the reactor pipe, there is a further constriction 9, which separates the cross-linking region 8 from the cooling zone 10 for the pre-cooling, in which there is an inert gas atmosphere of lower temperature and in which the pressure is the same as in the cross-linking zone 6 and the degassing zone 8. At the end of the cooling zone 10 there is a lock 11, which separates the inert gas atmosphere in the interior of the reactor pipe from the cooling zone 12, which is operated with a cooling liquid. In this cooling zone 12, the cable is cooled to such an extent, that it can be wound onto a cable drum.

The cross-linking agent, which is added to the insulation and/or semiconductor layer already before the extrusion, decomposed by the heat supplied and broken down into gaseous components, interferes not only in the cable but also in the inert gas atmosphere surrounding the cable in the interior of the reactor, because it interferes with the escape of these gaseous decomposition products. An exchange and a subsequent cleaning of the inert gas atmosphere are therefore provided. This is done in a cycle, so that the inert gas and the heat inherent in the latter can constantly be used once again.

In FIG. 1, the inert gas is withdrawn from the reaction pipe 6, 8, 10 at 13 and passes through the pipe, which serves as regeneration segment 14 and is passed through a cleaning device 15 and a heating device 16. In the cleaning device 15, the inert gas, withdrawn from the reactor pipe, is freed from the gaseous breakdown products. In the heating device 16 it is brought once again to the temperature required for the degassing and then introduced once again into the reactor pipe at the inlet 17. An arrow indicates the direction of flow of the inert gas.

In FIG. 2, this inert gas cycle is divided into two different cycles 18, one being for the cross-linking region 6 and the other for the degassing region 8. This also has advantages from an energy point of view. The directions of flow of the inert gas in the two cycles are indicated in each case by an arrow.

In FIG. 3, a vertical installation is shown. In this representation, the same reference numbers are used for objects, which are the same as in the previous Figures.

FIG. 4 shows the further treatment in the cooling zone 12 of the cable 4, emerging from the pre-cooling zone 10 of the catenary reactor pipe. After passing through the lock 11, the cable runs through a water-filled, pressurized cooling pipe 21, from which it emerges through the lock 22. After changing directions at the wheel 23, it passes through a tempering segment 24, in which any deformations of the insulation and/or semiconductor layer are eliminated by memory effects, before the cable 4, drawn by a drawing device 25, is wound up on a cable drum 27 in a winding device 26.

The invention accordingly relates to a method and an installation for cross-linking the insulation layer or the semiconductor layer of a cable, which is being produced and passing through a reaction chamber filled with pressurized hot inert gas. The installation is dominated by a very long reactor pipe, which requires a particularly long and, consequently, expensive production building. It is an object of the invention to carry out the cross-linking and any subsequent degassing more rapidly and less expensively. The invention consists therein that the conductor or conductors, moved continuously in the reaction chamber and accordingly cross-linked continuously, are heated more strongly by inductive heating. Due to this measure, the cross-linking, which progresses from the inside and the outside to the center of the insulation layer or semiconductor layer and which is associated with an increase in the dimensional stability, is utilized in order to permit the cross-linking to take place more rapidly by increasing the temperature in the interior, that is, in the conductor. As the cross-linking progresses, the increased dimensional stability of the insulation and/or semiconductor layer is used in order to increase the temperature of the conductor even further. Adjoining the cross-linking zone, a degassing zone is created by increasing the temperature further. In this degassing zone, a rapid exit of gas from the cable over a relatively short segment in the reaction chamber is brought about by inductive heating.

### LIST OF REFERENCE SYMBOLS

1 conductor
2 guide wheel
3 transversal extruder head
4 cable
5 induction heater
6 cross-linking zone
7 induction heater
8 degassing region
9 constriction
10 pre-cooling zone
11 lock
12 cooling design
13 withdrawing site
14 regeneration segment
15 cleaning device
16 heating device
17 inlet
18 inert gas cycle for the cross-linking region
19 inert gas cycle for the degassing region
20 inert gas cycle for the cooling zone
21 pressurized cooling pipe
22 lock
23 guide wheel
24 tempering segment
25 drawing-off device
26 winding device
27 cable drum

1. Method for cross-linking an insulation layer or semiconductor layer on at least one conductor of a cable, comprising passing said cable through a reaction chamber filled with pressurized, hot, inert gas, wherein as the cable advances in the reaction chamber, the cross-linking progresses and the at least one conductor is heated increasingly higher by inductive heating.

2. The method of claim 1, wherein as the cable advances in the reaction chamber, the crosslinking of an outer layer of the insulation layer or semiconductor layer of the cable progresses, and the heated inert gas atmosphere, which surrounds the cable in the reactor chamber, is heated increasingly higher.

3. The method of claim 1, wherein the inductive heating is carried out only when the cross-linking at the outer layer of the cable has brought about a dimensionally stable cross-linking of the outer layer of the cable by the convective heat of the hot inert gas.

4. The method of claim 1, further comprising:
performing a pre-reaction chamber heating of the at least one conductor, wherein the inductive heating in the reaction chamber is carried out only when the cross-linking of the inner layer of the insulation layer or semiconductor layer, facing the at least one conductor has brought about a dimensionally stable cross linking of the inner layer of the insulation layer or semiconductor layer due to the pre-reaction chamber heating supplied to the at least one conductor.

5. The method of claim 1, wherein the material from which the insulation layer or semiconductor layer is produced is heated up to its melting temperature.

6. The method of claim 1, further comprising degassing the cable after it is cross-linked but before it is cooled, by increasing the temperature of the cable in a pressurized atmosphere.

7. The method of claim 1 or 6, further comprising inductively heating the conductor before and/or during the entry into a degassing segment in the reaction chamber and/or during passage through the degassing segment in the reaction chamber to improve degassing by achieving an increase in inside cable temperature.

8. The method of claim 1 or 6, further comprising heating the pressurized gas, which surrounds the cable at the end of a cross-linking segment to improve degassing.

9. The method of claim 1 or 6, further comprising purifying an inert gas of a degassing segment wherein the inert gas is purified of gaseous breakdown products from the cross-linking reaction.

10. The method of claim 1 or 6, further comprising cycling an inert gas from a degassing segment, and an inert gas from a cross-linking segment through a cleaning device.

11. The method of claim 1 or 6, further comprising cycling an inert gas of a degassing segment and an inert gas of a cross-linking segment through separate cleaning devices.

12. The method of claim 1 or 6, further comprising winding up the cable, wherein a final degassing in surrounding atmosphere of air is carried out in temperature holding segments before or during the winding up said degassing being at a temperature of 40° to 100° C.

13. The method of claim 1 or 6, further comprising:
cooling: and
reheating to a temperature range a little below the melting point of the materials used to make the insulation layer or semiconductor layer or higher for activating restoring forces and memory effects to eliminate deformations of the cable developed during passage through equipment and during the cooling.

14. The method of claim 1 or 6, further comprising:
cleaning an inert gas from a degassing segment; and
recycling said inert gas into the degassing segment, wherein
the inert gas, after being cleaned and before re-entering the degassing segment, is heated to a temperature appropriate for the degassing.

15. The method of claim 1 or 6, further comprising a pre-cooling, wherein the cross-linking, the degassing and the subsequent pre-cooling are carried out in a common pipe, which is divided into the individual sections for the cross-linking, the degassing and the subsequent cooling by inlet and outlet connecting pieces for the warm, heated and cooled inert gas.

16. The method of claim 6, further comprosing a pre-cooling, wherein the cross-linking, the degassing and a subsequent pre-cooling are carried out in a common pipe, which is divided into individual sections for the cross-linking, the degassing and the subsequent cooling by locks and constrictions for the warm, heated and cooled inert gas.

17. Apparatus for cross-linking the insulation layer or semiconductor layer of a cable, said cable being passed through a reaction chamber filled with pressurized, hot, inert gas, comprising:
a reaction chamber; and
at least one inductive heating device, wherein
said at least one inductive heating device is disposed in at least one location where cross-linking has set in and led to a dimensional stability of an outer shape of the cable.

18. The apparatus according to claim 17, wherein at least one inductive heating device for the at least one conductor of the cable is disposed places where cross linking has set in and has led to a dimensional stability of an external shape of the cable.

19. The apparatus according to claim 17, wherein an inductive heating device in a cross-linking zone of the reaction chamber is adapted for increasing the temperature of the conductor or conductors of the cable being produced up to the melting temperature of the material of the insulation layer or semiconductor layer.

20. The apparatus according to claim 17, comprising a degassing segment between a cross-linking segment and a cooling segment, said degassing segment being filled with inert gas and working at an elevated temperature level and under pressure.

21. The apparatus according to claim 17, further comprising a cleaning device, wherein an inert gas is cycled in parallel between a degassing segment and said cleaning device.

22. The apparatus according to claim 17, further comprosing a cleaning device, wherein an inert gas from a cross-linking segment and a degassing segment is cycled through the cleaning device.

23. The apparatus according to claim 17, wherein a cross-linking segment is separated from the a degassing segment by a pipe constriction.

24. The apparatus according to claim 17, wherein
at least one heating device is provided in an inert gas cycle; and
said inert gas is from a degassing segment.

25. The apparatus according to claim 17, wherein an induction heater for heating the conductor is provided at an entrance of the a degassing segment.

26. The apparatus according to claim 17, wherein a heater for a purified inert gas is provided at an end of a cleaning segment.

27. The apparatus according to claim 17, further comprising individual sections of the reaction chamber for cross-linking, degassing, and cooling, wherein
cross-linking, degassing and cooling take place in a common pipe, and
individual sections for the cross-linking, the degassing and the subsequent cooling are divided by inlet and outlet connecting pieces for the warm, heated and cooled inert gas.

28. The apparatus according to claim 17, further comprising individual sections of the reaction chamber for cross-linking, degassing, and cooling, wherein
cross-linking, degassing and cooling take place in a common pipe, and
individual sections for the cross-linking, the degassing and the subsequent cooling are divided by locks or constrictions for warm, heated and cooled inert gas.

29. The apparatus according to claim 17, further comprising a tempering segment, wherein
continuous tempering is by a flow of warm air under atmospheric conditions.

30. The method of claim 6, further comprising winding up the cable, wherein a final degassing in surrounding atmosphere of air is carried out in temperature holding segments before or during the winding up, said degassing being at a temperature of 55° to 75° C.
